(19) United States
(12) Patent Application Publication
(10) Pub. No.: US 2009/0041065 A1
(43) Pub. Date: Feb. 12, 2009

(54) Liquid Crystal Device

(76) Inventors: Harry J. Coles, Cambridge (GB); Marcus J. Coles, Cambridge (GB); Benjamin J. Broughton, Cambridge (GB); Stephen M. Morris, Cambridge (GB); Alison D. Ford, Cambridge (GB)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/631,135

(22) PCT Filed: Jul. 4, 2005
(86) PCT No.: PCT/GB05/02622

§ 371 Date: Dec. 31, 2007

(30) Foreign Application Priority Data
Jul. 2, 2004 (GB) 0414888.8

(51) Int. Cl. H01S 3/10

(52) U.S. Cl. 372/20

(57) ABSTRACT

A tuneable laser device comprises first and second cell walls enclosing a layer of a liquid crystal material having a helical axis substantially normal to the inner surfaces of the cell walls in the absence of an applied field. The liquid crystal contains a fluorescent, phosphorescent, luminescent or rare-earth dye. The device includes electrodes for applying a transverse electric field substantially normal to the helical axis. The invention also provides a method of electrically adjusting the peak wavelength of a photonic band edge laser comprising a chiral nematic liquid crystal material having a helical axis and a fluorescent, phosphorescent, luminescent or rare-earth dye therein and optically pumped by a suitable light source. The method comprises applying an electric field substantially perpendicular to the helical axis so as to deform the helix by means of the flexoelectric effect.

### FIELD OF THE INVENTION

The present invention relates to liquid crystal devices, notably to a tuneable laser device and a beam steering device, and to methods of using the devices.

### BACKGROUND TO THE INVENTION

In recent years there have been a multitude of reports dedicated to creating photonic band gaps (PBG) structures in both organic¹⁻⁵ and inorganic⁶⁻⁸ materials. As a result of the natural helix formation, chiral nematic (N*) liquid crystals have played a key role in realising the potential of materials that possess a one-dimensional PBG for light¹⁻⁵. In some cases, chiral liquid crystals that exhibit a 1-D PBG for light have been targeted as potential circularly polarised light sources^{9,10}. The polarisation mode that resembles the rotation sense of the helix is suppressed within the regime of the band gap and only the opposite sense of polarisation is permitted. However, under the correct circumstances low-threshold lasing can occur at the photonic band edge¹¹ (PBE) where the density of photon states diverges, and this has been the focus of the majority of research conducted into chiral nematic photonic band gap materials¹².

To generate emission within the structure, typically, foreign fluorescent emitters have to be incorporated into the liquid crystal matrix. Although there have been examples² where the pure chiral nematic is used as the light emitter, this generally requires a pump source with a wavelength far in the ultra-violet. It has been shown¹ that one way to create a low-threshold PBE laser is to use a dye-doped chiral nematic liquid crystal whereby one edge of the photonic band gap overlaps the fluorescence curve of the dye. In order to minimise the excitation threshold factors such as the emission efficiency, the quantum efficiency of the dye, and the quality factor of the resonator must be maximised^{13, 14}.

One advantage of using chiral nematic liquid crystals is that they have unique electro-optic properties in contrast to conventional photonic crystals. A previous report¹⁵ has explored the effects on laser emission for dielectric coupling.

### SUMMARY OF THE INVENTION

According to an aspect of the present invention there is provided a tuneable laser device comprising first and second cell walls enclosing a layer of a liquid crystal material having a substantially uniformly orientated helical axis in the absence of an applied field, a fluorescent, phosphorescent, luminescent or rare-earth dye within the liquid crystal material, and electrodes for applying an electric field substantially normal to said helical axis.

We have found that application of a transverse electric field can be used to tune the laser wavelength. This electric, rather than thermal, control permits rapid and fine tuning of the laser wavelength.

The preferred liquid crystal material is a chiral nematic (cholesteric) of positive dielectric anisotropy. However, chiral tilted smectic materials or blue phase materials could alternatively be used. The chirality may be inherent in the nature of the liquid crystal material or it may be induced by inclusion of a chiral additive. Many suitable chiral additives are commercially available, for example BDH1305 or BDH1281 (Merck NB-C). The preferred helical pitch will depend upon the dye and the chiral nematic solvent being used. For dyes that emit in the visible the range of pitch lengths will be in the range 200-500 nm, with longer helical pitches being needed for telecommunications applications. The liquid crystal material may be synthesised to contain a fluorescent laser dye moiety, phosphorescent, luminescent or rare-earth dyes or it may have a fluorescent laser dye, such as DCM, or phosphorescent, luminescent or rare-earth dyes dissolved in it.

A preferred aspect of the invention provides a photonic band edge laser which is fabricated from a thin organic film containing a short-pitch dye-doped non-symmetric bimesogen sample. The lasing characteristics are adjustable under the influence of flexoelectric deformation of the N* helical axis, produced by an electric-field applied substantially perpendicular to this axis. It is found that the laser wavelength can be effectively tuned by the application of such a field. Without wishing to be bound by theory, we believe this effect to be due to shifting of the PBE as a result of the helix deformation common to the flexoelectro-optic effect in chiral nematics¹⁶.

Accordingly, another aspect of the invention provides a method of electrically adjusting the peak wavelength of a photonic band edge laser comprising a chiral nematic liquid crystal material having a helical axis and a fluorescent, phosphorescent, luminescent or rare-earth dyes therein and optically pumped by a suitable light source, the method comprising applying an electric field substantially perpendicular to said helical axis so as to deform the helix by means of the flexoelectric effect.

For most liquid crystal materials the flexoelectric coupling effect is very small and is typically swamped by the quadratic electric field dependence of the dielectric term. Recently however, a series of non-symmetric bimesogens have been synthesised that have been shown^{17, 18} to have enhanced flexoelectro-optic properties. These materials are particularly preferred as components of the liquid crystal material of the present invention.

The stop band of the chiral liquid crystal material has the secondary effect of reflecting light incident upon it for which there are no propagation modes. Therefore the flexoelectric distortion of the helix allows electric control of both the wavelength and direction of reflected light. A further aspect of the present invention therefore provides a flexoelectrically-controllable beam steering device using a chiral nematic or chiral tilted smectic liquid crystal material.

Other aspects and benefits of the invention will appear in the following specification, drawings and claims.

### BRIEF DESCRIPTION OF THE DRAWINGS

The invention will now be further described, by way of example, with reference to the following drawings in which:

FIG. 1 shows the molecular structure of the non-symmetric bimesogen host, FFO8OCB;

FIG. 2 shows the molecular structure of the DCM laser dye;

FIG. 3 is a photomicrograph of a transverse electrode electro-optic cell showing the 50 μm active region outlined in the centre;

FIG. 4 is an oscilloscope trace showing timing of the pump laser pulse within an applied electric field;

FIG. 5 is a graph of typical reflection spectra of a chiral nematic liquid crystal and lasing emission spectra from a dye-doped chiral nematic sample;

FIG. 6 shows excitation energy dependence of the emission energy of a DCM-doped FFO8OCB*PBE laser at different temperatures;

FIG. 7 shows PBE lasing emission spectra of the DCM-doped FFO8OCB* sample in the electro-optic cell of FIG. 3 for a range of electric field strengths, in accordance with an aspect of the present invention; and

FIG. 8 shows the peak lasing wavelength as a function of applied electric field for a device in accordance with an aspect of the present invention.

### DETAILED DESCRIPTION

### Materials and Experiment

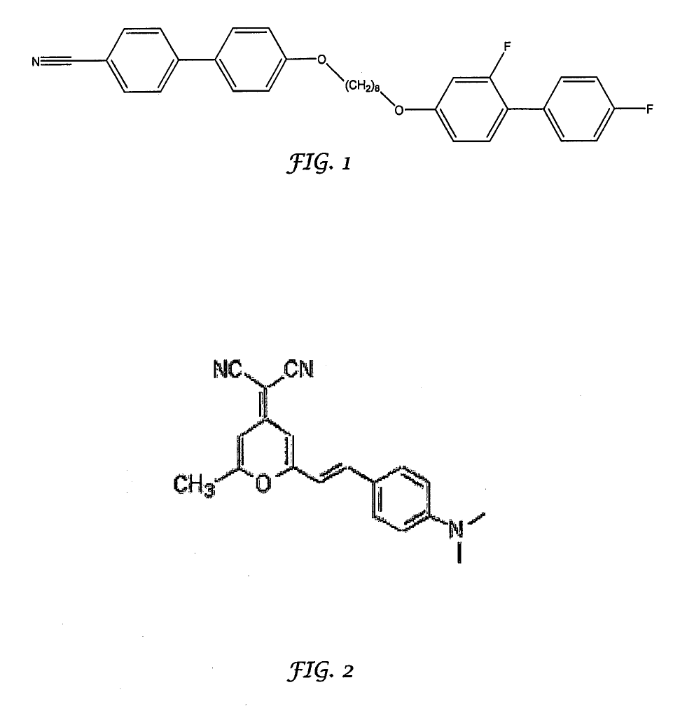

A sample was prepared using a non-symmetric bimesogen as the nematic liquid crystal host. The non-symmetric bimesogens α-(2′,4-difluorobiphenyl-4′-yloxy)-ω-(4-cyanobiphenyl-4′-yloxy) alkanes were synthesized in-house. The cyanobiphenyl mesogen and the 2,4′-difluorobiphenyl mesogens were connected by a flexible alkyl spacer. We have given the bimesogens the mnemonic FFOnOCB, where n corresponds to the number of methylene units in the flexible spacer. A preferred value for n is in the range 1-20. In this study we have used FFO8OCB as the nematic host. The ‘even’ length spacer means that the bimesogen, FFO8OCB, can lay anti-parallel in the all-trans conformation. The chemical structure is given in FIG. 1.

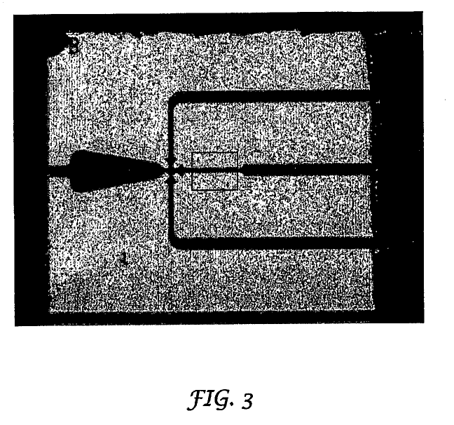

The nematic host was then mixed with a small concentration (˜5 wt %) of high twisting power chiral dopant (BDH1281, Merck NB-C) and the highly miscible laser dye, 4-(dicyanomethylene)-2-methyl-6-(4-dimethylaminostyryl)-4H-pyran (DCM, Lambda Physik) (˜2 wt %), the structure of which is shown in FIG. 2. The mixture was then heated in a bake oven at 150° C. for a period of twenty-four hours. From herein we refer to this mixture as DCM-doped FFO8OCB*. After mixing, the sample was then injected into a 7.5 μm-thick ‘lucid’ cell by means of capillary action. The substrates of the cell were substantially planar and coated with a rubbed polyimide layer to give an orientation such that the helix axis lies perpendicular to the planes of the glass substrates (Grandjean texture). The transition temperatures and the chiral nematic phase were identified using optical polarising microscopy and a Linkam hot-stage and controller. From optical polarising microscopy the clearing temperature, T_{c}, of the chiral nematic DCM-doped FFO8OCB* was found to be 144° C.

The experimental set-up for generating and detecting lasing is as follows. Sample cells were illuminated with the 532 nm line from a Q-switched Nd:YAG laser (Polaris II, New Wave Research). The beam was focused by an f=10 cm objective giving a spot size with a diameter of ˜160 μm at the sample. In order to adjust the temperature, the sample cell was placed in a custom built heating element/stage, which was controlled by a conventional Linkam controller. A fibre-optic bundle then collected the output and the emission was then resolved by a 0.04 nm-resolution spectrometer (HR2000, Ocean Optics). An edge filter was used to separate the pump and the sample laser beams. Emission energies of the liquid crystal laser were recorded using a high sensitivity energy meter (Laserstar, Ophir). All energy measurement results are averaged over 50 pulses.

Having confirmed lasing action in the plain 7.5 μm cell for the material involved, an electro-optic cell consisting of gold-deposited electrodes in the plane of the cell was filled and place in the pump beam. In this arrangement, the 10 μm thickness electrodes allow a uniform electric field to be applied perpendicular to both the helical axis (with the material in the Grandjean texture) and also act as spacer elements onto which the lid of the cell is fixed. These electrodes are separated by a 50 μm wide channel into which the sample is capillary filled. The cell lid is pre-coated with a unidirectionally rubbed layer of PTFE, while the base of the cell is spin-coated with 1% PVA solution in H₂O. While the electrodes on the base of the cell prevent directional rubbing of an alignment layer, it is found that these two layers in combination provide a Grandjean texture in which to induce lasing. A microscope image of the transverse electrode electro-optic cell used is shown in FIG. 3 and the 50 μm wide active region is boxed in the centre.

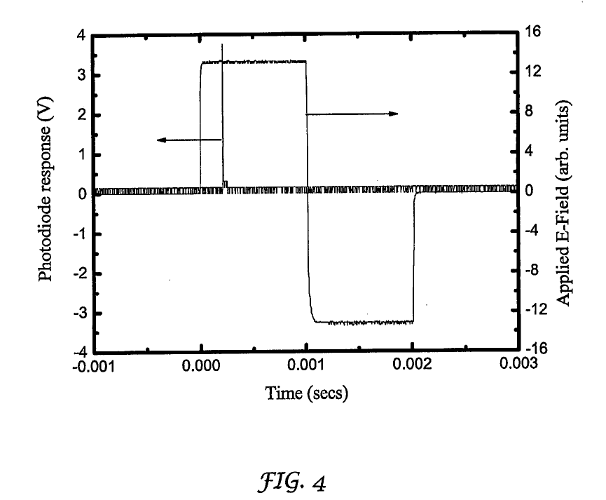

The electro-optic cell was allowed to stabilise to the application of the pump pulse, such that a uniform lasing output from the sample was observed, at which point an electronic pulse, amplified from a signal generator (TTI), was applied across the active area of the cell to coincide with the pulse from the pump beam. An oscilloscope trace showing the response of a photodiode to the pump pulse in relation to the applied electric field is shown in FIG. 4. It can be seen from this figure that a period of approximately 200 μs is allowed between the initial application of the electronic pulse and the incidence of the pump laser pulse. This is to allow the material to fully respond in its director deformation to the field before lasing is induced. Our previous unpublished work on the flexoelectro-optic effect in the Grandjean texture with non-symmetric bimesogens has shown the material response time to be of the order 100 μs¹⁹.

### Results and Discussion

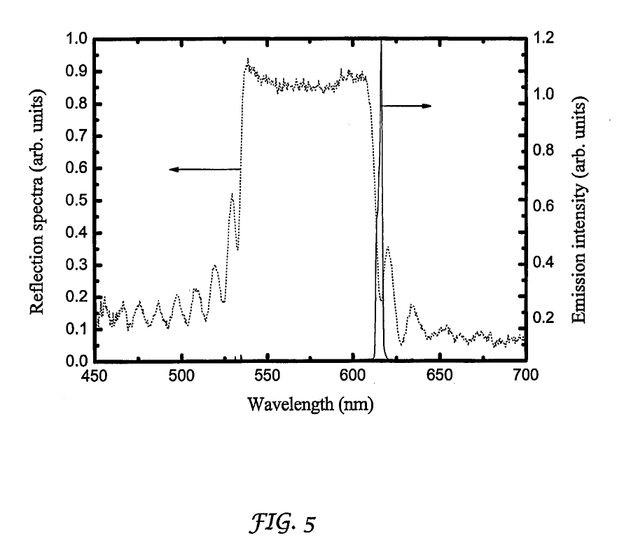

FIG. 5 shows typical reflection band and lasing emission spectra for PBE lasing at the gain maximum of DCM. The reflection band shown was obtained with the application of circularly polarized white light to a sample without DCM, to remove dye absorption effects which typically mask the short wavelength edge. In thin film cells subsidiary interference fringes are observed outside the reflection band, indicative of a well aligned monodomain sample. The figure also shows clearly the precise dependence of the lasing peak relative to the reflection band/photonic band gap. The peak occurs at the first absorption minimum at the long wavelength band edge.

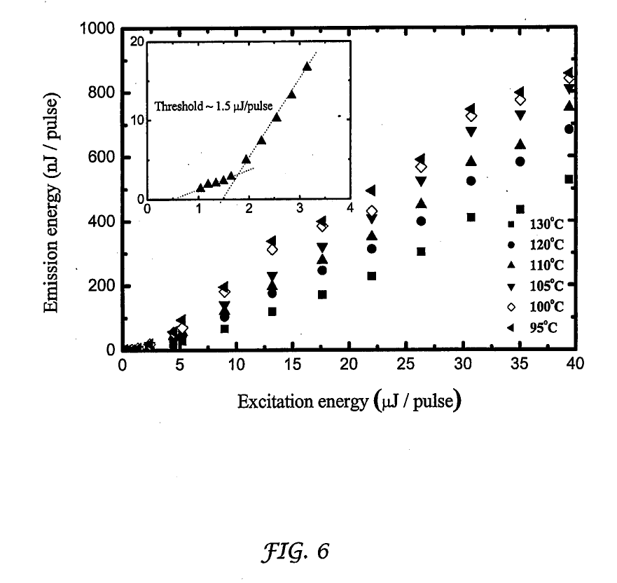

FIG. 6 shows the excitation energy dependence of the total emission energy of the DCM-doped FFO8OCB* PBE laser at several different temperatures. The inset of FIG. 6 allows for a closer inspection of the excitation threshold. At low excitation energies, spontaneous emission is observed, and for excitation energies greater than the lasing threshold, represented by the discontinuity in the differential, the total emission energy follows the familiar linear dependence with the input energy up until the saturation limit. At the highest excitation energies (>40 μJ/pulse) the cell begins to degrade, although not irreversibly, and the total emission energy starts to drop. The helical pitch was about 350 nm, and is substantially temperature-invariant for these measurements.

The thermal dependence of the operating efficiency observed for the PBE laser is also noteworthy. It is shown in FIG. 6 that the operating efficiency decreases at elevated temperatures. Since the PBE laser line remains within the spontaneous emission maximum of DCM (590 nm to 620 nm), it is therefore unlikely that this is responsible for the remarkable performance-related temperature dependence. However, the thermal dependence of the operating efficiency of a thermotropic PBE laser can be accounted for by the temperature tuning of the emission efficiency and the quality factor of the chiral nematic^{13,14}. For this reason field-controlled measurements using the electro-optic cell were carried out at a temperature where the operating efficiency was maximised.

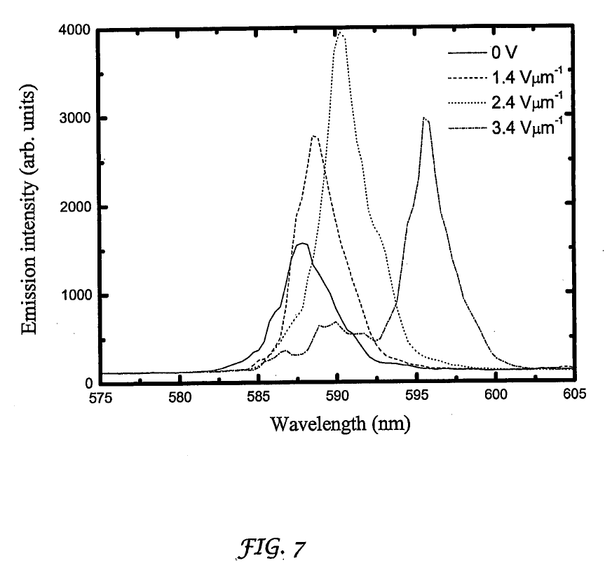

FIG. 7 shows the lasing spectra obtained from the sample at a series of applied electric fields. A general trend of increasing red-shift of the lasing peak with applied electric field can be seen. The intensity of the lasing varies slightly due to systematic fluctuation in the response to successive pump pulses recorded by the spectrometer. However, it is thought that the large variation in intensity shown here is principally due to the deforming of the chiral nematic helix which provides the reflection band, by the applied electric field, and degradation of the Grandjean texture. It is also thought that the latter is a major contributor to the increased spectral widths of the lasing emission observed in the electro-optic cell compared to that observed in the lucid cell¹⁷. Upon removal of the field, the laser emission line returned immediately to its original zero-field spectral position and intensity.

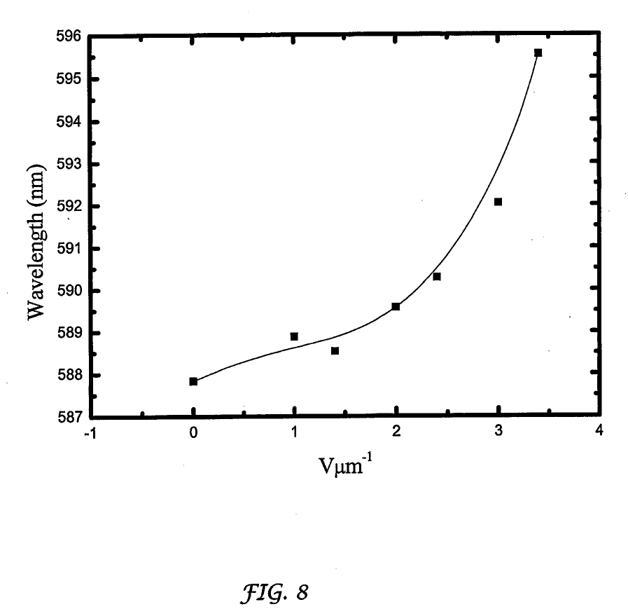

The extent of this red shifting can be clearly seen from the plot of peak laser wavelength against applied field shown in FIG. 8. The laser is tuned over a range of 8 nm for an electric field of 3.4 V/μm, the maximum available from the amplifier used, and the degree of tuning is precisely controlled by the magnitude of the applied field.

### SUMMARY

In conclusion, we have demonstrated photonic band edge lasing in non-symmetric bimesogens which are known to have both high optic-axis tilt angles and fast response times when flexoelectrically coupled to an applied field. We have also demonstrated for the first time electronically controlled tuning of a chiral nematic PBE laser. It is thought that the tuning observed is a result of the flexoelectric deformation of the chiral nematic helix of the material, in a mechanism equivalent to the flexoelectric rotation of the optic axis of a chiral nematic in the uniform lying helix texture. In addition, we have found that a bimesogen with an even or odd number of methylene units in the alkyl spacer is suitable for photonic band edge lasing.

The principal limitations to the electronic tuning observed so far are the relatively small field strengths applied, and the lack of complete monodomain uniformity of the sample texture. Bimesogens can couple flexoelectrically to fields of up to about 20 V/μm before dielectric coupling becomes dominant, so larger tuning ranges ought to be achieveable with an improved signal amplifier. Improvements in the cell alignment layer and annealing of the texture ought also to narrow the spectral width of the lasing peaks considerably, allowing greater resolution of the peak wavelength and its field dependence.

It is appreciated that certain features of the invention which are, for clarity, described in the context of separate embodiments, may also be provided in combination in a single embodiment. Conversely, various features of the invention which are, for brevity, described in the context of a single embodiment, may also be provided separately, or in any suitable combination.

It is to be recognized that various alterations, modifications, and/or additions may be introduced into the constructions and arrangements of parts described above without departing from the scope of the present invention as set forth in the claims.

### REFERENCES

1) V. I. Kopp, B. Fan, H. K. M. Vithana, A. Z. Genack, Opt. Lett. 23, 1707 (1998)
2) A. Munoz, P. Palffy-Muhoray, B. Taheri, Opt. Lett. 26, 804 (2001)
3) W. Cao, A. Munoz, P. Palffy-Muhoray, B. Taheri, Nature Materials 1, 111 (2002)
4) M. Voigt, M. Chambers, M. Grell, Chem. Phys. Lett., 347, 173 (2001)
5) M. Voigt, M. Chambers, M. Grell, Liq. Cryst. 29, 653 (2002)
6) J. D. Joannopoulos, R. D. Meade, J. N. Winn, Photonic Crystals: Moulding the Flow of Light, (Princeton University Press) (1995)
7) C. M. Soukoulis, (Ed.) Photonic Band Gaps and Localisation, NATO ASI Series B: Applied Sciences, Vol. 315 Kluwer Academic, Dordrecht, The Netherlands (1996)
8) A. Adibi, A. Scherer, S.-Y. Lin, (Eds.) Photonics Bandgap Materials and Devices, Proceedings of the SPIE International Society of Optical Engineering 4655 (2002)
9) S. H. Chen, D. Katsis, A. W. Schmid, J. C. Mastrangelo, T. Tsutsui, and T. N. Blanton, Nature, 397, 506 (1999)
10) D. Katsis, D. U. Kim, H. P. Chen, L. J. Rothberg, S. H. Chen, T. Tsutsui, Chem. Mater., 13, 643 (2001)
(11) J. P. Dowling, M. Scalora, M. J. Bloemer, and C. M. Bowden, J. Appl. Phys., 75, 1896 (1994)
(12) For a review of photonic band edge lasing in dye-doped cholesteric liquid crystals see V. I. Kopp, Z-Q. Zhang, and A. Z. Genack, Prog. Quant. Electron. 27(6), 369 (2003)
(13) P. V. Shibaev, V. Kopp, A. Genack, and E. Hanelt, Liq. Cryst. 30, 1391 (2003)
(14) S. M. Morris, A. D. Ford, M. N. Pivnenko, and H. J. Coles, submitted J. Appl. Phys.
(15) S. Furumi, S. Yokoyama, A. Otomo, and S. Mashiko, Appl. Phys. Letts., 82, 16 (2003)
(16) J. S. Patel, R. B. Meyer, Phys Rev Lett, 58, 15, p. 1538, 1987.
(17) M. J. Clarke, thesis in preparation, University of Southampton
(18) H. J Coles, M. J. Coles, S. Perkins, B Musgrave and D. Coates, Bimesogenic Compounds and Flexoelectric Devices. GB2356629. Filed September 1999. Published 30 May 2001
(19) B. J. Broughton, paper in preparation

1-28. (canceled)

29. A tuneable laser device comprising first and second cell walls enclosing a layer of a liquid crystal material having a substantially uniformly orientated helical axis in the absence of an applied field, a fluorescent, phosphorescent, luminescent or rare-earth dye within the liquid crystal material, and electrodes for applying an electric field substantially normal to said helical axis.

30. A device according to claim 29, wherein said helical axis is substantially normal to the inner surfaces of the cell walls.

31. A device according to claim 29, wherein the liquid crystal material is a chiral nematic liquid crystal of positive or negative dielectric anisotropy.

32. A device according to claim 29, wherein the liquid crystal material consists of or includes a bimesogen.

33. A device according to claim 32, wherein the bimesogen comprises at least one α-(2′,4-difluorobiphenyl-4′-yloxy)-ω-(4-cyanobiphenyl-4′-yloxy)alkane having from 1 to 20 carbons in the alkane chain.

34. A device according to claim 33, wherein said bimesogen is α-(2′,4-difluorobiphenyl-4′-yloxy)-ω-(4-cyanobiphenyl-4′-yloxy)octane (FIG. 1).

35. A device according to claim 29, wherein the dye is 4-(dicyanomethylene)-2-methyl-6-(4-dimethylaminostyryl)-4H-pyran (FIG. 2).

36. A device according to claim 29, wherein the dye has a bimesogenic structure containing a fluorescent, phosphorescent, luminescent or rare-earth moiety.

37. A device according to claim 29, further including a light absorber dissolved in the liquid crystal material, said light absorber having a bimesogenic structure and having a light absorbing moiety which allows Forster transfer of excitation energy to said fluorescent, phosphorescent, luminescent or rare-earth dye.

38. A device according to claim 37, wherein said light absorbing moiety is an azo-moiety.

39. A device according to claim 29, further comprising a light input source arranged to illuminate the liquid crystal material with light of a wavelength suitable for absorption by said dye.

40. A device according to claim 39, wherein said light input source is arranged to direct light at a location between said electrodes and substantially parallel to said helical axis.

41. A device according to claim 40, wherein said helical axis is substantially normal to the inner surfaces of the cell walls.

42. A device according to claim 39, wherein said light input source is a Q-switched Nd:YAG laser, electro-luminescent light source, organic light emitting diode or laser diode.

43. A device according to claim 29, wherein said electrodes comprise at least four electrodes arranged around a region of the liquid crystal layer, each electrode being selectively addressable to apply an electric field across said region, whereby said electric field may be applied in any of a plurality of selectable directions.

44. An electrically tuneable laser device comprising opposed, substantially planar spaced-apart first and second translucent cell walls enclosing a layer of a chiral nematic liquid crystal material of positive dielectric anisotropy having a substantially uniformly orientated helical axis in the absence of an applied field, a fluorescent, phosphorescent, luminescent or rare-earth dye within the liquid crystal material, electrodes on at least one inner surface of said cell walls for applying an electric field substantially normal to said helical axis, and a light source for optically pumping said dye.

45. A device according to claim 44, wherein said chiral nematic liquid crystal material comprises α-(2′,4-difluorobiphenyl-4′-yloxy)-ω-(4-cyanobiphenyl-4′-yloxy)octane (FIG. 1) and a chiral dopant.

46. A device according to claim 44, wherein said helical axis is substantially normal to the planes of the inner surfaces of the cell walls

47. A device according to claim 44, wherein said electrodes comprise at least four electrodes arranged around a region of the liquid crystal layer, each electrode being selectively addressable to apply an electric field across said region, whereby said electric field may be applied in any of a plurality of selectable directions.

48. A device according to claim 44, wherein said light source is arranged to direct light along said helical axis.

49. A method of electrically adjusting the peak wavelength of a photonic band edge laser comprising a chiral nematic liquid crystal material having a helical axis and a fluorescent phosphorescent, luminescent or rare-earth dye therein and optically pumped by a suitable light source, the method comprising applying an electric field substantially perpendicular to said helical axis so as to deform the helix by means of the flexoelectric effect.

50. A method according to claim 49, wherein said chiral nematic liquid crystal material has substantially planar alignment.

51. A method according to claim 49, wherein the electric field is a substantially DC field having a field strength in the range 1-20 V/μm.

52. A method according to claim 49, wherein the helical axis is lying in the plane of a cell comprising opposed substantially planar cell walls, and the field is applied between the cell walls.

53. A method of electrically adjusting the direction of a beam of selectively reflected light from a chiral nematic liquid crystal material having a helical axis, the method comprising applying an electric field substantially perpendicular to said helical axis so as to deform the helix by means of the flexoelectric effect.

54. A method according to claim 53, wherein the electric field is a substantially DC or low frequency AC field having a field strength in the range 1-20 V/μm.

55. A method according to claim 53, wherein the liquid crystal material contains a fluorescent, phosphorescent, luminescent or rare-earth dye.
